(19) United States
(12) Patent Application Publication
(10) Pub. No.: US 2009/0061189 A1
(43) Pub. Date: Mar. 5, 2009

(54) "Balanced" Engineered Wood Composite Comprising "Unbalanced" Wood Materials and Method Therefor

(75) Inventors: Nianhua Ou, Dacula, GA (US); Jason Corey Tolar, Athens, GA (US); Thomas Leon Lee, JR., Statham, GA (US); Timothy William Romans, Rockwood, TN (US)

Correspondence Address: J M HUBER CORPORATION, 333 THORNALL STREET, PATENT DEPARTMENT, EDISON, NJ, 08837-2220, US

(73) Assignee: HUBER ENGINEERED WOODS LLC, Charlotte, NC (US)

(21) Appl. No.: 11/845,970

(22) Filed: Aug. 28, 2007

(51) Int. Cl. B32B 7/02; B29C 65/00; B32B 21/00

(52) U.S. Cl. 428/218; 156/64; 428/292.4

(57) ABSTRACT

A composite engineered wood panel comprising a top surface layer and a bottom surface layer. The layers comprise amounts of lignocellulosic material with particular densities. The bottom layer comprises more lignocellulosic material and lignocellulosic material moisture in amounts effective to produce an essentially symmetrical vertical density profile through the panel upon consolidation of a formed panel. The panel can further comprise at least one core layer. The top surface layer preferably comprises primarily softwood, and the other layers preferably comprise primarily hardwood. Also disclosed is a method of making the panel.

### BACKGROUND

Composite engineered wood products such as particle board and oriented strand board (OSB) are known in the art. Composite engineered wood products were originally made in response to the need for an alternative to solid wood because of dramatically shrinking supplies of wood and an increasing desire for wood conservation. The engineered wood product industry has now also felt the effect of diminished sources of wood, or at least of diminished resources of particular wood species.

Composite engineered wood products such as OSB are currently generally made of softwood in the southern U.S. (in particular, pine, even more particularly, southern pine) because of its moderate specific gravity, high strength and stiffness, ease in cutting into flakes, low curling flakes, and light color, as well as being a species indigenous to the local wood baskets.

Because of a shortage of softwood, manufacturers desire the ability to use hardwood as a substitute for or filler material with the softwood without diminishing mechanical and aesthetic properties of products made therefrom.

There is a strong relationship between the properties of wood and the properties of the particular species that yielded it. For every trees species, there is a range of densities for the wood it yields. There is a rough correlation between density of a wood and its strength (mechanical properties).

Most softwood species and several soft hardwood species (i.e., yellow poplar and aspen) demonstrate traits favorable to OSB production, such as ease of stranding (e.g., low fines generation, flat strands, low knife wear, flakes with optimal geometry without log pre-treatment). Softwood, such as pine, has a lower density and higher stiffness compared to many hard hardwood species. An engineered wood composite panel with a surface made up of mostly pine reduces the occurrence of surface voids and strand pops on the panel surface.

Many hardwood species, particularly hard hardwood species, such as oaks, hickories, and gums, do not possess the characteristics that are optimum for OSB production. Instead, hardwoods have high fines generation, curled strands, produce quicker knife wear, and less than optimum strand geometry (e.g., narrow strands and more splitting). Species such as hickory are much harder than pine and dull strander knives much faster than pine. Oak also causes faster knife wear than pine, but also produces narrower strands and any wide strands tend to curl. Sweet gums tend to curl as well when stranded due to interlocking grain of this species. With all of the hardwood species and many others, the fines generation observed during stranding is greater than that of pine and some softwood. Pre-treatment of hard hardwood logs with steam and hot water soaks can improve some of these characteristics, but pre-treatment costs time and money and has environmental considerations. Hardwood, such as oak, hickory, or maple, has higher specific gravity, darker color or non-uniform color, and difficulty in flaking. When used in an engineered wood composite, many hardwood species must have the overall mat weight increased relative to a mat made of softwood to maintain the same amount of furnish volume in the mat due to the higher specific gravity of the hardwood.

Table 1 shows illustrative differences in moisture content and density of various wood species.

TABLE 1
Comparative properties of various wood species.

| | | Avg. moisture | |
|---|---|---|---|
| | Specific | content | Volume shrinkage % |
| Species | gravity | of green wood* | from green to oven dry |
| Hickory, mockernut | 0.64 | | 17.8 |
| Hickory, pignut | 0.66 | | 17.9 |
| Maple, red | 0.49 | | 12.6 |
| Maple, sugar | 0.66 | 65-72% | 14.7 |
| Oak, southern red | 0.52 | | 16.1 |
| Oak, white | 0.66 | 64-78% | 12.7 |
| Pine, loblolly | 0.54 | 33-110% | 12.3 |
| Poplar, yellow | 0.40 | | 12.7 |
| Sweet gum | 0.46 | | 15.8 |

*based on weight when oven dry

Composite engineered wood products, such as OSB, are generally made of layers wherein the layers comprise wood, binder, and, optionally, other ingredients. It is common knowledge in the industry that composite engineered wood products made up of layers must be “balanced” to avoid problems with dimensional stability of the product, such as cupping and/or bowing. For example, in an oriented strand board (OSB) panel consisting of three layers, the surface layer (top and bottom surface) materials are conventionally manufactured with material of about equal densities and/or moisture contents so that the panel will remain flat during production and post-production.

The balancing of products is conventionally accomplished by producing layers containing wood (and other ingredients) wherein the layer's ingredients are balanced, i.e., have matching properties, e.g., top and bottom surface layers both made of equal amounts of pine wood and having equal moisture contents. Matching materials with equal properties presents a problem, however, when due to the limited resource of pine, other species of wood are needed to be utilized, primarily hardwood species. Another problem faced when matching materials is manufacturers do not want to impact the makeup of a composite's top surface, i.e., the one the customer sees, which generally consists of nearly 90% pine.

For these reasons, there exists a need for a composite engineered wood panel which can effectively utilize mixed wood species, but eliminates the undesired effects such as cupping and/or bowing associated with mixing wood species in a panel.

### SUMMARY

Described herein is a composite engineered lignocellulosic panel comprising a top surface layer comprising a first amount of lignocellulosic material moisture and a first amount of lignocellulosic material with a first density, and a bottom surface layer comprising a second amount of lignocellulosic material moisture and a second amount of lignocellulosic material with a second density, wherein the second amount of lignocellulosic material is greater than the first amount of lignocellulosic material and wherein the second amount of lignocellulosic material moisture measured prior to final consolidation and pressing of the panel is greater than the first amount of lignocellulosic material moisture whereby the combination of the greater amount of moisture and greater amount of lignocellulosic material is effective to produce an essentially symmetrical vertical density profile through the panel upon consolidation of a formed panel.

Also described herein is a composite engineered wood panel comprising a top surface layer and a bottom surface layer. The panel can further comprise at least one core layer. The bottom surface layer comprises about 2 wt % to about 6 wt %, preferably about 2 wt % to about 4 wt %, greater moisture content in the flakes (wt % based on weight moisture to total dry wood weight in the particular layer) than the top surface layer when measured prior to final pressing of the panel (which consolidates the mat forming the panel and cures resins). The bottom surface layer comprises about 4 wt % to about 8 wt %, preferably about 4 wt % to about 6 wt %, greater weight wood (wt % based on total layer weight=wood weight+resin weight+wax weight+other weight, i.e., the weight of the blended flakes or furnish) than the top surface layer. The engineered wood composite panel is essentially flat when produced and post-production because the panel has an essentially symmetrical vertical density profile through the panel.

The wood content of the top surface layer is primarily softwood, e.g., pine, in particular, about 70 wt % to about 100 wt % (weight of wood species vs. total weight of wood in the layer), or more particularly, greater than or equal to about 90 wt %. The wood content of the bottom surface layer can be primarily hardwood, in particular, about 70 wt % to about 100 wt % hardwood (weight of wood species vs. total wood weight of the layer), or more particularly, greater than or equal to about 90 wt % hardwood.

Described herein is a method for forming an engineered wood composite panel comprising stranding wood comprising at least one softwood species and at least one hardwood species, drying the stranded softwood to a first flake moisture content, drying the stranded hardwood to a second flake moisture content, mixing the stranded softwood with a binder, mixing the stranded hardwood with a binder, forming a bottom surface layer by orienting a first amount of the stranded hardwood-binder mixture, forming a top surface layer by orienting a second amount of the stranded softwood-binder mixture, wherein the bottom surface and top surface layers together comprise a mat and wherein the bottom surface layer comprises a flake moisture content about 2 wt % to about 6 wt % greater than a flake moisture content of the top surface layer wherein the flake moisture content is measured prior to final consolidation and pressing of the panel and is based on dry wood weight of the moisture content's layer wherein the bottom surface layer comprises a wood content about 4 wt % to about 8 wt % greater than the top surface layer based on the total weight of a layer, and pressing the formed mat under conditions effective to cure the binder and consolidate the mat thereby forming a consolidated panel with an essentially symmetrical vertical density profile through the panel.

Further described is a panel made by the method.

Additional advantages will be set forth in part in the description which follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate several aspects described below. The Figures were generated from the panel information in the Example section below.

FIG. 1 is a graph illustrating the effect of surface wood flake moisture content (wt %) on final engineered wood composite panel cupping where the top surface layer comprises 90+ wt % pine (weight pine vs. total weight of wood in the layer) and the bottom surface layer comprises 90+ wt % hardwood (weight hardwood vs. total weight of wood in the layer).

FIG. 2 is a graph illustrating density measurement (lb/ft³, vertical density profile, VDP) across a 3 layer engineered wood composite panel's thickness. Zone 1 is a 90+ wt % pine top surface layer. Zone 2 is an about 100 wt % hardwood (HW) core layer. Zone 3 is a 90+ wt % hardwood bottom surface layer. The pine to hardwood surface flake moisture content ratio is 6 wt % top surface to 4 wt % bottom surface (weight moisture vs. total weight dry wood in the particular layer).

FIG. 3 is a graph illustrating density measurement across a 3 layer engineered wood composite panel's thickness. Zone 1 is a 90+ wt % pine top surface layer. Zone 2 is an about 100 wt % HW core layer. Zone 3 is a 90+ wt % hardwood bottom surface layer. The pine top surface to hardwood bottom surface flake moisture content ratio is 6 wt % to 6 wt %.

FIG. 4 is a graph illustrating density measurement across a 3 layer engineered wood composite panel's thickness. Zone 1 is a 90+ wt % pine top surface layer. Zone 2 is an about 100% HW core layer. Zone 3 is a 90+ wt % hardwood bottom surface layer. The pine top surface to hardwood bottom surface flake moisture content ratio is 6 wt % to 10 wt %.

FIG. 5 is a graph illustrating the effect of weight content (wt % based on total weight of the corresponding layer) of wood on a 3 layer engineered wood composite panel's cupping where the top surface layer is 90+ wt % pine and the bottom surface layer is 90+ wt % hardwood (core about 100% HW).

FIG. 6 is a graph illustrating density measurement (lb/ft³) across a 3 layer engineered wood composite panel's thickness. Zone 1 is a 90+ wt % pine top surface layer. Zone 2 is an about 100% HW core layer. Zone 3 is a 90+ wt % hardwood bottom surface layer. The pine top layer to hardwood bottom layer ratio of weight % is 28 wt % to 36 wt % (weight of species vs. total weight of layer).

FIG. 7 is a graph illustrating density measurement across a 3 layer engineered wood composite panel's thickness. Zone 1 is a 90+ wt % pine top surface layer. Zone 2 is an about 100% HW core layer. Zone 3 is a 90+ wt % hardwood bottom surface layer. The pine top layer to hardwood bottom layer ratio of weight % is 36 wt % to 28 wt %.

### DETAILED DESCRIPTION

Before the present compositions, articles, and/or methods are disclosed and described, it is to be understood that the aspects described below are not limited to specific embodiments; specific embodiments as such may, of course, vary. It is also to be understood that the terminology used herein is for the purpose of describing particular aspects only and is not intended to be limiting.

In this specification and in the claims which follow, reference will be made to a number of terms which shall be defined to have the following meanings:

It must be noted that, as used in the specification and the appended claims, the singular forms “a,” “an,” and “the” include plural referents unless the context clearly dictates otherwise. Thus, for example, reference to “an additive” includes mixtures of additives or more than one additive; reference to “a lignocellulosic material” includes mixtures of two or more such materials, and the like.

“Optional” or “optionally” means that the subsequently described event or circumstance may or may not occur, and the description includes instances where the event or circumstance occurs and instances where it does not.

Ranges may be expressed herein as from “about” one particular value, and/or to “about” another particular value. When such a range is expressed, another aspect includes from the one particular value and/or to the other particular value. Similarly, when values are expressed as approximations by use of the antecedent “about,” it will be understood that the particular value forms another aspect. It will be further understood that the endpoints of each of the ranges are significant both in relation to the other endpoint, and independently of the other endpoint.

References in the specification and concluding claims to parts by weight of a particular element or component in a composition or article, denotes the weight relationship between the element or component and any other elements or components in the composition or article for which a part by weight is expressed. Thus, in a composition containing 2 parts by weight of component X and 5 parts by weight component Y, X and Y are present at a weight ratio of 2:5 and are present in such ratio regardless of whether additional components are contained in the composition.

A weight percent of a component, unless specifically stated to the contrary, is based on the total weight of the formulation or composition in which the component is included.

As used herein, “lignocellulosic material” is intended to mean a cellular structure, having cell walls composed of cellulose and hemicellulose fibers bonded together by lignin polymer. Wood is a species of lignocellulosic material.

By “wood composite material” or “wood composite component” it is meant a composite material that comprises lignocellulosic material and one or more other additives, such as resins/adhesives or waxes. Non-limiting examples of wood composite materials include oriented strand board (OSB), waferboard, particle board, chipboard, medium-density fiberboard, plywood, and boards that are a composite of strands and ply veneers. As used herein, “flakes”, “strands”, and “wafers” are considered equivalent to one another and are used interchangeably. A non-exclusive description of wood composite materials may be found in the Supplement Volume to the Kirk-Othmer Encyclopedia of Chemical Technology, pp. 765-810, 6th Edition, which is hereby incorporated by reference.

A “balanced” composite engineered wood panel made up of “unbalanced” lignocellulosic materials was developed. Through controlling the unbalanced lignocellulosic materials in the forming process, a balanced composite was produced, i.e., though the individual species of materials used may be “unbalanced,” the entire panel is “balanced.”

Conventionally, to produce a balanced engineered wood composite panel, one of ordinary skill in the art wants to use equal amounts (weights) of the same composition wood material to make up both surface layers in a layered panel. This composition matching conventionally includes using the same species of wood (or at least matched wood properties), the same moisture contents, and the like.

In the present invention, panels can comprise different species of wood in the panel layers. For example, the top surface comprises primarily softwood, preferably pine; the other layer(s) comprise primarily hardwood. These lignocellulosic materials have different densities.

In a panel of the present invention, flake moisture contents for the pine and hardwood used in the panel surfaces were adjusted or maintained to be higher in the surface layer comprising primarily hardwood species. This moisture control greatly reduced cupping and allowed for a more even contraction and densification of the two surfaces during pressing. Proper moisture control enables a panel producer to take two lignocellulosic materials that are of different starting densities and make them more equal densities during the pressing stage of the process of forming the panel. The increased moisture level of the primarily hardwood layer of the panel furnish allows this layer to densify at a rate and degree more closely matched to the densification of the primarily pine surface layer. The production of a flat composite panel with unequal moisture contents at the top and bottom surface layers contradicts the conventional wisdom in the industry of designing an engineered wood composite panel.

A hardwood surface layer furnish containing greater flake moisture content than that of the pine surface layer furnish is not enough to produce a flat panel by itself. Because many hardwood species have a potential to shrink more during densification on average than pine species, there is a need to restrain the hardwood from shrinking, which would cause the panel to cup. Therefore, cupping in a panel was further reduced by controlling the top surface layer to bottom surface layer wood weight ratio.

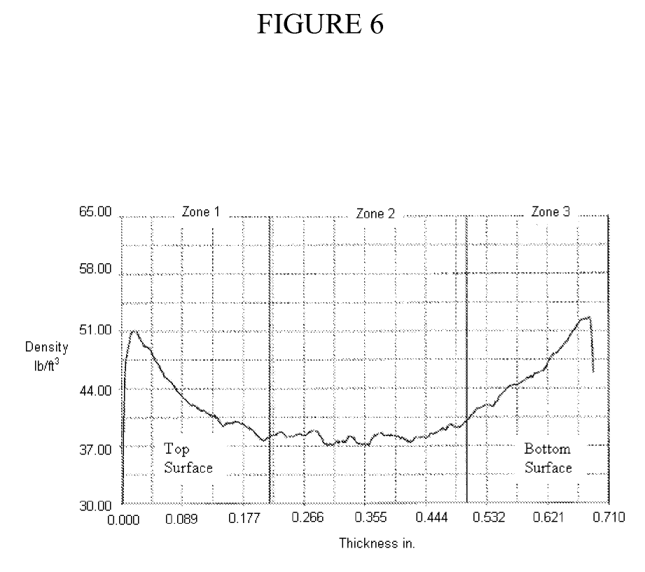

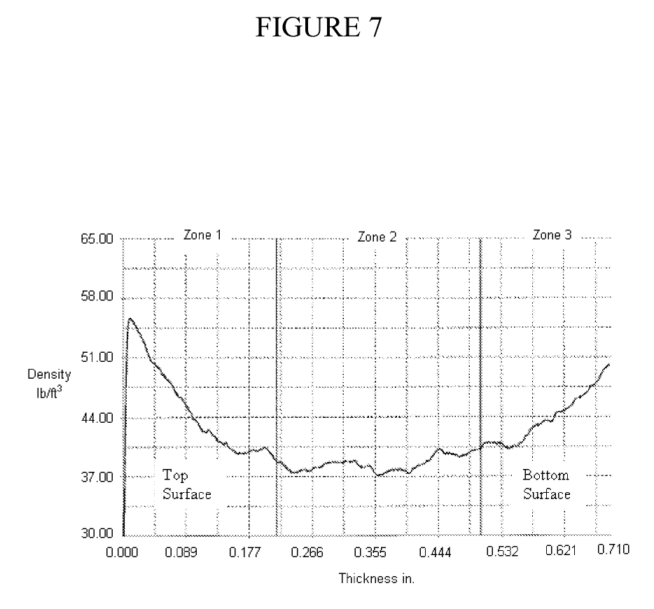

Hardwood strands are of a greater density than pine strands, but pine strands densify at a faster rate than hardwood strands during pressing, if both types of species contain equal moisture contents. An engineered wood composite panel with a more equal top surface to bottom surface density profile, which results in a more balanced and flatter panel (see, e.g., VDP diagrams in FIGS. 6-7), was produced by increasing the amount (weight) of wood material in the bottom surface layer of the panel (primarily hardwood) relative to the amount of wood material in the top surface layer (to further influence the surface densities). The density of the pine surface layer approaches a density level that is close that of hardwood (oak) surface layer upon pressing. Oak is more difficult to densify than pine at equal moistures, pressures, and temperatures.

### A. Composition/Article

A “balanced” composite engineered wood panel made up of “unbalanced” species of lignocellulosic materials was developed. A composite engineered wood panel of the invention comprises a top surface layer and a bottom surface layer. A composite engineered wood panel of the invention can further comprise a core layer.

In an example embodiment, a panel of the invention is a composite engineered lignocellulosic panel comprising a top surface layer comprising a first amount of lignocellulosic material moisture and a first amount of lignocellulosic material with a first density, and a bottom surface layer comprising a second amount of lignocellulosic material moisture and a second amount of lignocellulosic material with a second density, wherein the second amount of lignocellulosic material is greater than the first amount of lignocellulosic material, and wherein the second amount of lignocellulosic material moisture measured prior to final consolidation and pressing of the panel is greater than the first amount of lignocellulosic material moisture, whereby the combination of the greater amount of moisture and greater amount of lignocellulosic material is effective to produce an essentially symmetrical vertical density profile through the panel upon consolidation of a formed panel.

In another example embodiment, a panel of the invention is a composite engineered wood panel comprising a top surface layer comprising a first amount of lignocellulosic material moisture and a first amount of lignocellulosic material comprising at least about 70 wt % softwood or soft hardwood, and a bottom surface layer comprising a second amount of lignocellulosic material moisture and a second amount of lignocellulosic material comprising at least about 70 wt % hardwood, wherein the second amount of lignocellulosic material is greater than the first amount of lignocellulosic material by about 4 wt % to about 8 wt % based on the total weight of a layer, and wherein the second amount of lignocellulosic material moisture measured prior to final consolidation and pressing of the panel is greater than the first amount of lignocellulosic material moisture by about 2 wt % to about 6 wt % based on dry lignocellulosic material weight of a layer, and wherein a formed consolidated panel has an essentially symmetrical vertical density profile through the panel.

A composite engineered wood panel of the invention comprises a top surface layer. The top surface layer of a panel is the layer to be seen by the consumer (face outward in an end use)—the aesthetic surface, or one upon which other materials will be placed or attached. The top surface layer comprises at least about 70 wt %, preferably at least about 90 wt %, softwood wood species, wherein the weight percentage is calculated based on the total weight of all wood in the layer. The preferred softwood species is pine. The top surface layer can comprise at least about 73 wt %, 75 wt %, 78 wt %, 80 wt %, 82 wt %, 85 wt %, 87 wt %, 91 wt %, 92 wt %, 93 wt %, 94 wt %, 95 wt %, 96 wt %, 97 wt %, 98 wt %, or 99 wt % softwood. Alternatively, a soft hardwood, such as those already used in conventional panels, can be used.

A composite engineered wood panel of the invention comprises a bottom surface layer. The bottom surface layer is located opposite the top surface layer and is generally the surface of the panel placed on supporting construction, such as trusses or studs. The bottom layer comprises hardwood wood species. A bottom surface layer comprises at least about 70 wt %, preferably at least about 90 wt %, hardwood, wherein the weight percentage is calculated based on the total weight of all wood in the layer. The bottom surface layer can comprise at least about 73 wt %, 75 wt %, 78 wt %, 80 wt %, 82 wt %, 85 wt %, 87 wt %, 91 wt %, 92 wt %, 93 wt %, 94 wt %, 95 wt %, 96 wt %, 97 wt %, 98 wt %, or 99 wt % hardwood.

A composite engineered wood panel of the invention can further comprise a core layer. A core layer is located between the top surface layer and the bottom surface layer. A core layer can comprise any wood species or mixture of species. Even though the wood can comprise any species (i.e., 0-100% softwood or 0-100% hardwood), in a situation with a reduced softwood supply, hardwood can be used. A core layer can comprise, for example, at least about 70 wt %, or even at least about 90 wt %, hardwood. A core layer can comprise at least about 73 wt %, 75 wt %, 78 wt %, 80 wt %, 82 wt %, 85 wt %, 87 wt %, 91 wt %, 92 wt %, 93 wt %, 94 wt %, 95 wt %, 96 wt %, 97 wt %, 98 wt %, or 99 wt % hardwood.

The softwood in the panel can be, for example, pine, in particular, southern yellow pine. Some soft hardwoods, such as aspen and yellow poplar, can also be used. One of ordinary skill in the art can determine which soft hardwoods are appropriate for use in a panel of the present invention.

The hardwood in the panel can be, for example, oak, hickory, maple, beech, sweet gum, elm, and the like.

As is known to one of ordinary skill in the art, mixtures of different species can be used, e.g., any softwood when the composition calls for softwood. One of ordinary skill in the art can determine appropriate mixtures based on known wood characteristics, or if necessary, use of routine experimentation.

It is believed that the concept of this composition and article can be expanded to lignocellulosic materials other than wood, e.g., bamboo, sugar cane, and/or straw. One of ordinary skill in the art can determine appropriate species and ranges of material weights and moisture contents when using other lignocellulosic materials by using routine experimentation and the teachings herein.

Each layer of a composite engineered wood panel of the invention can comprise additional components that facilitate formation of the panel and contribute to the panel's properties. These components are conventional for the type of composite engineered wood panel. For example, in an OSB panel, each layer also comprises a resin binder and other additives (e.g., wax). One of ordinary skill in the art can determine these additional conventional components and the appropriate amount of each in any layer and the panel overall.

Typical moisture content in an engineered wood composite panel, e.g., an OSB panel, is about 3% to 12%. In a panel of the current invention, the ratio of flake moisture in the top surface layer to flake moisture in the bottom surface layer is controlled. Flake moisture content for the bottom surface layer, comprising primarily hardwood, is kept higher—about 2 wt % to about 6 wt % greater than the flake moisture content in the top surface layer (wt % is calculated based on weight of moisture in the layer to the total dry wood weight in the particular layer)—to reduce cupping and allow for a more even contraction and densification of the primarily pine (top) and primarily hardwood (bottom) surfaces during pressing. Preferably, the flake moisture content of the bottom surface layer is about 2 wt % to about 4 wt % higher than the flake moisture content in the top surface layer. This moisture difference is measured prior to final pressing of the panel. Pressing consolidates the furnish mat (and usually is also when cure of the resin binder occurs).

The ratio of weight of wood strands in the top and bottom surface layers is also controlled in a panel of the invention. Increasing the amount of hardwood material in the bottom surface layer of the panel allows further influence of the panel surface densities. A difference of about 4 wt % to about 8 wt % increase by weight of hardwood in the bottom surface layer versus wt % softwood (e.g., pine) in the top surface layer yielded the most favorable results. Preferably, the hardwood wood content of the bottom surface layer is about 4 wt % to about 6 wt % higher than the softwood wood content in the top surface layer. Weight percentage of a wood species is calculated based on weight of the wood species type (e.g., softwood) relative to total weight of all components in a layer, e.g., wood weight+resin weight+wax weight+other weight, i.e., the weight of the blended flakes or furnish.

This control of flake moisture and weight of wood strands allows production of a panel with a more equal top surface to bottom surface density profile, which results in a more balanced and flatter panel.

Broadly, an essentially symmetrical vertical density profile across a panel's thickness will prevent problems with cupping and create essentially flat panels. Based on this teaching and the additional teachings herein, one of ordinary skill in the art can determine variations of the current invention with no more than routine experimentation, for example, using various mixtures of various lignocellulosic materials with various “recipes” of binders and the like and adjusting parameters such as moisture and weight of the layers created in order to produce an essentially flat panel.

A panel of the invention can be made using a method as described in the Methods section below.

### B. Methods

A panel of the invention can be made using conventional manufacturing steps relevant to the type of composite engineered wood panel.

For example, an illustrative process for manufacturing an OSB panel embodiment of the invention is described below. OSB generally has multiple layers of wood “flakes” or “strands” bonded together by a resin binder.

The flakes are made, for example, by cutting logs into thin slices with a knife edge parallel to the length of a debarked log. The cut flakes are broken into narrow strands generally having lengths oriented parallel to the wood grain that are larger than the widths. The flakes are, typically, 0.01 to 0.05 inches thick (although thinner and thicker flakes can be used in some applications) and are, typically, less than one inch to several inches long and less than one inch to a few inches wide. One of ordinary skill in the art can determine the appropriate size of flakes/strands for a particular application. Various methods and equipment for debarking, flaking/stranding, and sizing are known to one of ordinary skill in the art.

In a process of the present invention, logs from at least one softwood species and at least one hardwood species are debarked and flaked. The softwood flakes and hardwood flakes will generally be treated separately in the downstream processing steps in order to control the amount of each in a panel.

In the fabrication of oriented strand board, flakes are first dried to remove water and then are coated in a blender with a thin layer of binder and sizing agent. Typically, the resin and sizing agent comprise less than 10% by weight of the oriented strand board. One of ordinary skill in the art can determine the appropriate binder, sizing agent, other components, and amounts thereof for a particular application. One of ordinary skill in the art can determine the appropriate amount of moisture to dry from the wood flakes for a particular application. Various methods and equipment for drying, coating, and mixing/blending the flakes and binder are known to one of ordinary skill in the art.

The coated flakes are then spread on a conveyor belt to provide a first surface ply or layer having flakes oriented generally in line with the conveyor belt. The “streams” of hardwood and softwood can be laid separately in different passes and/or layers or can be mixed prior to forming into a mat. Then, one or more plies that will form an interior ply or plies (core layer(s)) of the finished board is (are) deposited on the first ply such that the one or more plies is (are) oriented generally perpendicular to the conveyor belt. Then, another surface ply having flakes oriented generally in line with the conveyor belt is deposited over the intervening one or more plies having flakes oriented generally perpendicular to the conveyor belt. Plies built-up in this manner have flakes oriented generally perpendicular to a neighboring ply insofar as each surface ply and the adjoining interior ply. Alternatively, one of ordinary skill in the art can determine other orientations for the strands in the layers, e.g., parallel or random. One of ordinary skill in the art can determine the appropriate thickness of each layer, appropriate number of layers, and appropriate composition for each layer to use for a particular application. Various methods and equipment for forming, orienting, and conveying the layered mat are known to one of ordinary skill in the art.

The layers of oriented “strands” or “flakes” are finally exposed to heat and pressure to bond the strands and binder together (consolidate and cure). The resulting product is then cut to size and shipped. One of ordinary skill in the art can determine the appropriate consolidation and curing to use for a particular application, e.g., cold press and UV or microwave cure. Various methods and equipment for consolidating and curing the layered mat are known to one of ordinary skill in the art.

In a method of the present invention, hardwood and softwood can be, and are preferably, separated during processing (e.g., debarking, stranding, drying, blending, and forming). This facilitates control over the amount of each type of wood and its location in a panel. The flake moisture content (pre-pressing moisture) can be adjusted, for example, by amount of drying, water spray in the blender, water spray in the forming line, or combinations thereof. Various methods and equipment for separation and flake moisture addition or removal are known to one of ordinary skill in the art.

Once formed and post-production, a panel of the present invention should stay essentially as flat as any panel made of conventionally balanced materials.

In an example embodiment, a method of forming an engineered wood composite panel comprises stranding wood comprising at least one softwood species and at least one hardwood species; drying the stranded softwood to a first moisture content; drying the stranded hardwood to a second moisture content; mixing the stranded softwood with a binder; mixing the stranded hardwood with a binder; forming a bottom surface layer by orienting a first amount of the stranded hardwood-binder mixture; forming a top surface layer by orienting a second amount of the stranded softwood-binder mixture; wherein the bottom surface and top surface layers together comprise a mat, and wherein the bottom surface layer comprises a strand moisture content about 2 wt % to about 6 wt % greater than a strand moisture content of the top surface layer wherein the moisture content is measured prior to final consolidation and pressing of the panel and is based on dry wood weight of the moisture content's layer, wherein the bottom surface layer comprises a wood content about 4 wt % to about 8 wt % greater than the top surface layer based on the total weight of a layer; and pressing the formed mat under conditions effective to cure the binder and consolidate the mat, thereby forming a consolidated panel with an essentially symmetrical vertical density profile through the panel.

### C. Utility

The panels of the invention can be used conventionally as any other composite engineered wood panels. For example, OSB can be used as subflooring; sheathing for walls and roof in building construction; concrete forms; and window, door, or furniture parts.

### EXAMPLES

The following examples are put forth so as to provide those of ordinary skill in the art with a complete disclosure and description of how the compositions, articles, and/or methods described and claimed herein are made and evaluated and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of process conditions, e.g., component concentrations, temperatures, pressures and other ranges and conditions that can be used to optimize the product obtained from the described process. Only reasonable and routine experimentation will be required to optimize such process conditions.

### Example 1

### Production of Panels

Southern yellow pine and mixed hardwoods (hickory, maple, poplar) strands, ¼″ to greater than 2″ in length and target thickness of 0.027″, were supplied by the Huber Engineered Woods LLC Whites Creek, Tenn. mill.

The pine strands were resinated in a drum style mixer with polymeric diphenylmethane diisocyanate (MDI) (Mondur® 541, Bayer MaterialScience LLC, Pittsburgh, Pa.) at 5.00% solids (% based on weight of formed mat, Table 2) and powder phenol-formaldehyde (PPF) (Dynea 13D036, Dynea, Powder Resin Division, North Bay, Ontario, Canada) at 2.00% solids (% based on weight of formed mat, Table 2). The hardwood strands were resinated with the same MDI at 5.00% solids. Slack wax (Esso Petroleum, Ontario, Canada) was applied to all the strands at an add-on rate of 2.0% solids (% based on weight of formed mat, Table 2). The application order was water, wax, MDI, and PPF. Atomizing nozzles were used to apply MDI, tap wax, and water. The PPF was added manually to the blender.

Four panels were formed and pressed using hardwood and softwood strands. Upon examination, it was found that the fines in the hardwood strands had migrated to the bottom surface of the panels. Therefore, the hardwood strands were screened for > 3/16″ size on a deck screener before use in the other panels. The fines were not screened out prior to formation of mats in panels 1-1, 1-2, 1-5, and 1-6 (Tables 2 & 4).

The blended surface materials for the top face and bottom face layers were mechanically formed on a sealed caul screen, and the core was hand formed, into 58″×108″ mats. Mat formation had a target density of 43 lb/ft³.

The formed mats were pressed to a target thickness of ¾″ using a PressMAN® Press Monitoring System (Alberta Research Council, Edmonton, Alberta, Canada) to program, monitor, and control the press. Teflon® release sheets were placed on top of the mats, and BlackHawk BSP EX55 release agent was applied with a roller to the screens and the press. Press time was 280 sec. at a temperature of 410° F.

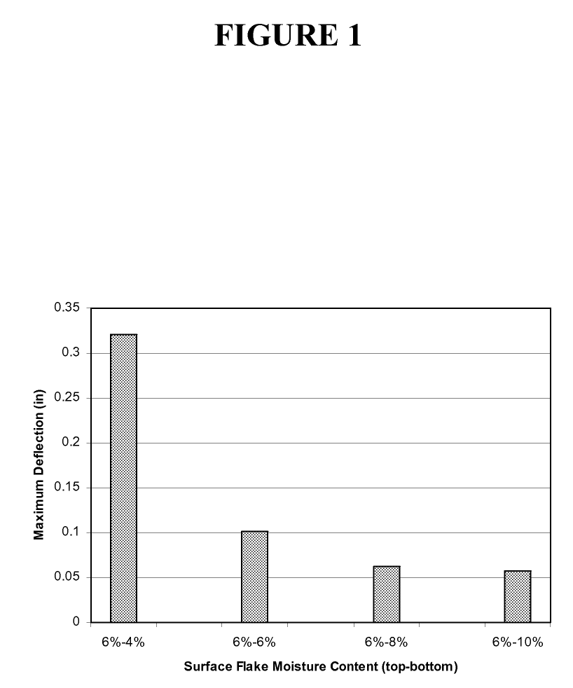

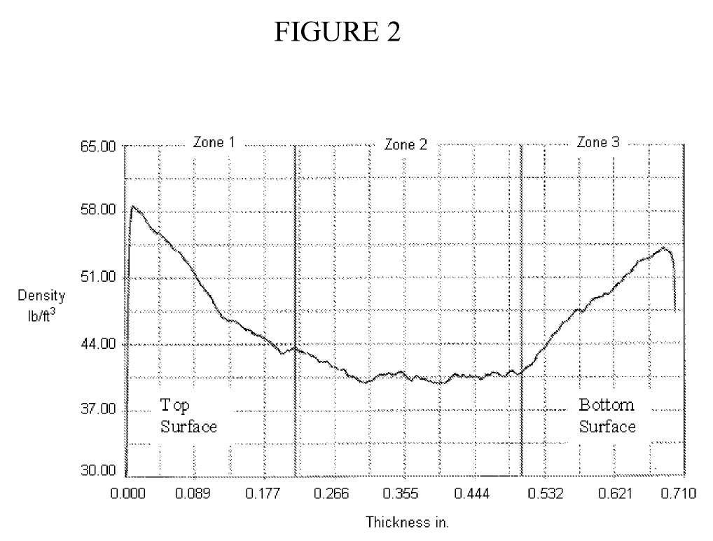

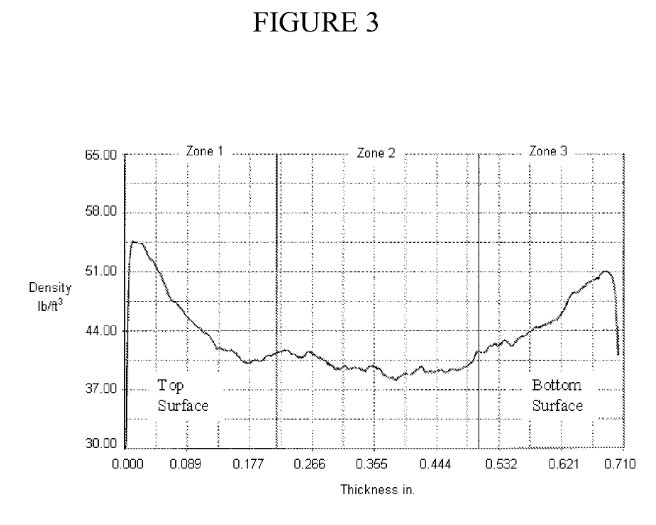

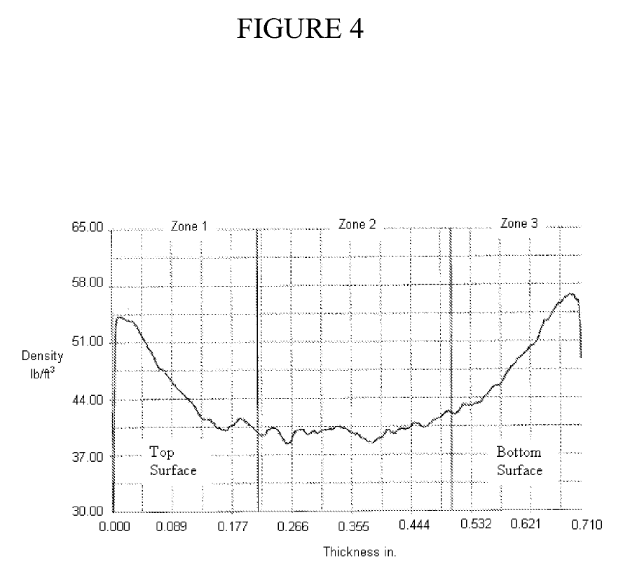

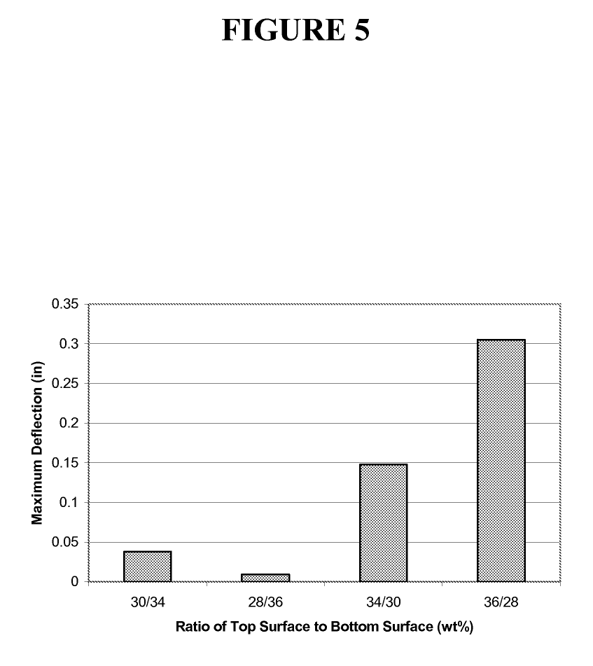

After pressing, the panels were trimmed to 48″×96″ and measured for out-of-press thickness and density. FIGS. 1-7 illustrate the results.

TABLE 2
Panel measurements.

| | | | Thickness (in.) | | Density (lb/ft³) | | Moisture (%) | |
|---|---|---|---|---|---|---|---|---|
| | Weight (lb.) | | | dev. from | nominal | avg. | Avg. | |
| ID | Mat | Panel | Avg. | nominal | thickness | thickness | furnish | Est. panel |
| 1-1 | 118.50 | 115.63 | 0.767 | 0.017 | 40.5 | 39.6 | 5.0 | 2.5 |
| 1-2 | 126.32 | 122.05 | 0.760 | 0.010 | 46.5 | 45.9 | 4.9 | 1.3 |
| 1-3 | 118.06 | 114.31 | 0.747 | −0.003 | 43.4 | 43.5 | 5.7 | 2.3 |
| 1-4 | 118.39 | 127.43 | 0.749 | −0.001 | 43.3 | 43.3 | 5.9 | 14.0 |
| 1-5 | 122.36 | 117.62 | 0.750 | 0.000 | 44.7 | 44.7 | 6.2 | 2.1 |
| 1-6 | 120.92 | 116.18 | 0.743 | −0.007 | 44.7 | 45.1 | 6.1 | 1.9 |
| 1-7 | 118.39 | 112.22 | 0.741 | −0.009 | 42.0 | 42.5 | 7.4 | 1.8 |
| 1-8 | 121.25 | 115.63 | 0.744 | −0.006 | 43.9 | 44.3 | 7.5 | 2.5 |
| 1-9 | 118.94 | 115.52 | 0.758 | 0.008 | 42.7 | 42.3 | 5.0 | 2.0 |
| 2-1 | 118.72 | 114.20 | 0.744 | −0.006 | 43.8 | 44.2 | 6.2 | 2.2 |
| 2-2 | 118.39 | 114.09 | 0.753 | 0.003 | 43.2 | 43.0 | 6.0 | 2.2 |
| 2-3 | 118.39 | 114.09 | 0.753 | 0.003 | 44.0 | 43.8 | 5.9 | 2.1 |
| 2-4 | 118.50 | 113.65 | 0.753 | 0.003 | 43.5 | 43.3 | 5.5 | 1.2 |
| 2-5 | 118.50 | 114.31 | 0.753 | 0.003 | 43.7 | 43.5 | 5.5 | 1.8 |
| 2-6 | 118.39 | 113.98 | 0.752 | 0.002 | 43.0 | 42.9 | 5.4 | 1.5 |
| 2-7 | 118.50 | 114.31 | 0.756 | 0.006 | 43.2 | 42.9 | 5.7 | 2.0 |
| 2-8 | 118.50 | 113.76 | 0.759 | 0.009 | 42.9 | 42.4 | 5.3 | 1.1 |
| 3-1 | 118.50 | 112.88 | 0.753 | 0.003 | 43.2 | 43.0 | 5.5 | 0.5 |
| 3-2 | 118.50 | 114.09 | 0.756 | 0.006 | 43.4 | 43.0 | 5.5 | 1.6 |

Warp deflection of the panels was measured approximately 1 hour after panel removal from the press.

Panels 1-1 to 1-9 had weight ratios of top surface 32% pine, core 36% hardwood, and bottom surface 32% hardwood. Panels 2-1 to 2-8 had weight ratios shown in Table 3.

TABLE 3
Weight ratios of wood species.

| | Ratio wt % | | |
|---|---|---|---|
| | (wood species weight in layer | | |
| | relative to weight of layer) | | |
| | Top face | Core | Bottom face |
| Panel ID | pine | HW | HW |
| 2-1 | 30 | 36 | 34 |
| 2-2 | 28 | 36 | 36 |
| 2-3 | 34 | 36 | 30 |
| 2-4 | 36 | 36 | 28 |
| 2-5 | 30 | 36 | 34 |
| 2-6 | 28 | 36 | 36 |
| 2-7 | 34 | 36 | 30 |
| 2-8 | 36 | 36 | 28 |

Panels 3-1 and 3-2 both had wood ratios of top surface pine 15% and hardwood 17%, core hardwood 36%, and bottom surface hardwood 17% and pine 15%. The top surface layer had an outermost pine only area with a hardwood only area underneath the pine but still in the top surface layer. Likewise, the bottom surface layer had a hardwood only area near the core and a pine only area in the outermost area of the layer.

Nine panels of the formed OSB with different moisture contents of the bottom face strands were analyzed for panel properties and cupping. Eight panels of the formed OSB with selected top layer and bottom layer surface weight ratios were analyzed for panel properties and cupping. Two panels of the formed OSB with 15% pine in the top layer and bottom layer surfaces were analyzed for panel properties and panel deflection.

TABLE 4
Results of formed panels.

| | Face: southern yellow pine | | | | | | | | | | |
|---|---|---|---|---|---|---|---|---|---|---|---|
| | MDI 5.00% solids, PPF 2.00% solids | | | | | | Core: Hardwood | | | Measured deflection | |
| | Top pine face | | | Bottom hardwood face | | | MDI 5.00% solids | | | North | South |
| | Blended | MC % | Line | Blended | MC % | Line | Blended | MC % | Line | side | side |
| Panel ID | MC % | added | MC % | MC % | added | MC % | MC % | added | MC % | (in.) | (in.) |
| 1-1^{†} | 6.1 | 0.0 | 6.2 | 3.7 | 1.6 | 4.8 | 4.1 | 2.0 | 5.0 | 0.429 | 0.350 |
| 1-2^{†} | 6.1 | 0.0 | 6.0 | 3.7 | 1.6 | 4.7 | 4.1 | 2.0 | 4.9 | 0.309 | 0.195 |
| 1-3^{†} | 7.2 | 2.8 | 6.6 | 5.8 | 2.4 | 6.3 | 4.5 | 1.3 | 5.7 | 0.101 | 0.073 |
| 1-4^{†} | 7.2 | 2.8 | 7.0 | 5.8 | 2.4 | 6.3 | 4.5 | 1.3 | 5.9 | 0.161 | 0.071 |
| 1-5^{†} | 6.1 | 0.0 | 6.1 | 8.8 | 7.6 | 8.7 | 4.1 | 2.0 | 6.2 | 0.073 | 0.104 |
| 1-6^{†} | 6.1 | 0.0 | 5.6 | 8.8 | 7.6 | 8.7 | 4.1 | 2.0 | 6.1 | 0.036 | 0.035 |
| 1-7^{†} | 7.2 | 2.8 | 7.3 | 11.5 | 8.1 | 10.9 | 4.5 | 1.3 | 7.4 | 0.054 | 0.080 |
| 1-8^{†} | 7.2 | 2.8 | 7.3 | 11.5 | 8.1 | 11.2 | 4.5 | 1.3 | 7.5 | 0.056 | 0.037 |
| 1-9^{†} | 6.6 | 3.9 | 7.0 | 4.2 | 1.9 | 4.2 | 3.8 | 1.9 | 5.0 | —* | —* |
| 2-1^{‡} | 6.3 | 3.6 | 7.5 | 7.3 | 5.2 | 7.6 | 3.8 | 0.5 | 6.2 | 0.000 | 0.071 |
| 2-2^{‡} | 6.3 | 3.6 | 7.7 | 7.3 | 5.2 | 6.9 | 3.8 | 0.5 | 6.0 | 0.131 | 0.168 |
| 2-3^{†} | 6.3 | 3.6 | 6.7 | 7.3 | 5.2 | 7.4 | 3.8 | 0.5 | 5.9 | 0.184 | 0.000 |
| 2-4^{†} | 6.4 | 4.3 | 6.1 | 6.4 | 4.3 | 7.0 | 3.8 | 0.5 | 5.5 | 0.282 | 0.221 |
| 2-5^{†} | 6.6 | 3.9 | 6.9 | 6.3 | 4.0 | 6.0 | 3.8 | 1.2 | 5.5 | 0.223 | 0.000 |
| 2-6 | 6.6 | 3.9 | 6.6 | 6.3 | 4.0 | 6.0 | 3.8 | 1.2 | 5.4 | 0.000 | 0.000 |
| 2-7^{†} | 6.6 | 3.9 | 7.1 | 6.3 | 4.0 | 6.5 | 3.8 | 1.2 | 5.7 | 0.199 | 0.208 |
| 2-8^{†} | 6.6 | 3.9 | 6.2 | 6.3 | 4.0 | 5.9 | 3.8 | 1.2 | 5.3 | 0.342 | 0.376 |
| 3-1^{†} | 6.4 | 4.3 | 6.6 | 6.4 | 4.3 | 6.5 | 3.8 | 0.5 | 5.6 | 0.145 | 0.100 |
| 3-2^{†} | 6.6 | 3.9 | 6.9 | 6.3 | 4.0 | 6.3 | 3.8 | 1.2 | 5.6 | 0.000 | 0.086 |

MC = moisture content
*= top surface was kept 5″ below orienting discs; second pass was 10″ below to create more of a random effect
^{†}= cup up from screen side
^{‡}= cup down toward screen side

Throughout this application, various publications may be referenced. The disclosures of these publications in their entireties are hereby incorporated by reference into this application in order to more fully describe the compositions and methods described herein.

Various modifications and variations can be made to the compositions and methods described herein. Other aspects of the compositions and methods described herein will be apparent from consideration of the specification and practice of the compositions and methods disclosed herein. It is intended that the specification and examples be considered as exemplary.

What is claimed is:

1. A composite engineered wood panel comprising
a top surface layer comprising a first amount of lignocellulosic material moisture and a first amount of lignocellulosic material comprising at least about 70 wt % softwood or soft hardwood, and
a bottom surface layer comprising a second amount of lignocellulosic material moisture and a second amount of lignocellulosic material comprising at least about 70 wt % hardwood
wherein the second amount of lignocellulosic material is greater than the first amount of lignocellulosic material by about 4 wt % to about 8 wt % based on the total weight of a layer and
wherein the second amount of lignocellulosic material moisture measured prior to final consolidation and pressing of the panel is greater than the first amount of lignocellulosic material moisture by about 2 wt % to about 6 wt % based on dry lignocellulosic material weight of a layer and
wherein a formed consolidated panel has an essentially symmetrical vertical density profile through the panel.

2. The panel of claim 1 further comprising at least one core layer comprising a third amount of lignocellulosic material comprising at least about 90 wt % hardwood.

3. The panel of claim 1 wherein the first amount of lignocellulosic material comprises at least about 90 wt % softwood or soft hardwood.

4. The panel of claim 1 wherein the second amount of lignocellulosic material comprises at least about 90 wt % hardwood.

5. The panel of claim 1 wherein the first amount of lignocellulosic material comprises at least about 90 wt % pine and the second amount of lignocellulosic material comprises at least about 90 wt % hardwood.

6. The panel of claim 1 wherein the softwood or soft hardwood is a pine, aspen, poplar, or mixtures thereof.

7. The panel of claim 1 wherein the softwood or soft hardwood is softwood.

8. The panel of claim 7 wherein the softwood is pine.

9. The panel of claim 1 wherein the hardwood is oak, hickory, maple, beech, sweet gum, elm, or mixtures thereof.

10. The panel of claim 1 wherein the second amount of lignocellulosic material is greater than the first amount of lignocellulosic material by about 4 wt % to about 6 wt %.

11. The panel of claim 1 wherein the second amount of lignocellulosic material moisture measured prior to final consolidation and pressing of the panel is greater than the first amount of lignocellulosic material moisture by about 2 wt % to about 4 wt %.

12. The panel of claim 1 wherein the second amount of lignocellulosic material is greater than the first amount of lignocellulosic material by about 4 wt % to about 6 wt % and the second amount of lignocellulosic material moisture measured prior to final consolidation and pressing of the panel is greater than the first amount of lignocellulosic material moisture by about 2 wt % to about 4 wt %.

13. A composite engineered wood panel produced by a method comprising
stranding wood comprising at least one softwood species and at least one hardwood species,
drying the stranded softwood to a first moisture content,
drying the stranded hardwood to a second moisture content,
mixing the stranded softwood with a binder,
mixing the stranded hardwood with a binder,
forming a bottom surface layer by orienting a first amount of the stranded hardwood-binder mixture,
forming a top surface layer by orienting a second amount of the stranded softwood-binder mixture,
wherein the bottom surface and top surface layers together comprise a mat and wherein the bottom surface layer comprises a strand moisture content about 2 wt % to about 6 wt % greater than a strand moisture content of the top surface layer wherein the strand moisture content is measured prior to final consolidation and pressing of the panel and is based on dry wood weight of the moisture content's layer
wherein the bottom surface layer comprises a wood content about 4 wt % to about 8 wt % greater than the top surface layer based on the total weight of a layer, and
pressing the formed mat under conditions effective to cure the binder and consolidate the mat
thereby forming a consolidated panel with an essentially symmetrical vertical density profile through the panel.

14. A method of forming an engineered wood composite panel comprising
stranding wood comprising at least one softwood species and at least one hardwood species,
drying the stranded softwood to a first moisture content,
drying the stranded hardwood to a second moisture content,
mixing the stranded softwood with a binder,
mixing the stranded hardwood with a binder,
forming a bottom surface layer by orienting a first amount of the stranded hardwood-binder mixture,
forming a top surface layer by orienting a second amount of the stranded softwood-binder mixture,
wherein the bottom surface and top surface layers together comprise a mat and wherein the bottom surface layer comprises a strand moisture content about 2 wt % to about 6 wt % greater than a strand moisture content of the top surface layer wherein the moisture content is measured prior to final consolidation and pressing of the panel and is based on dry wood weight of the moisture content's layer wherein the bottom surface layer comprises a wood content about 4 wt % to about 8 wt % greater than the top surface layer based on the total weight of a layer, and
pressing the formed mat under conditions effective to cure the binder and consolidate the mat
thereby forming a consolidated panel with an essentially symmetrical vertical density profile through the panel.

15. The method of claim 14 further comprising forming at least one core layer by orienting a third amount of the stranded hardwood-binder mixture.

16. The method of claim 14 further comprising adding water to the stranded hardwood-binder mixture, the stranded softwood-binder mixture, or the bottom surface layer.

17. A composite engineered lignocellulosic panel comprising
a top surface layer comprising a first amount of lignocellulosic material moisture and a first amount of lignocellulosic material with a first density, and
a bottom surface layer comprising a second amount of lignocellulosic material moisture and a second amount of lignocellulosic material with a second density wherein the second amount of lignocellulosic material is greater than the first amount of lignocellulosic material and
wherein the second amount of lignocellulosic material moisture measured prior to final consolidation and pressing of the panel is greater than the first amount of lignocellulosic material moisture
whereby the combination of the greater amount of moisture and greater amount of lignocellulosic material is effective to produce an essentially symmetrical vertical density profile through the panel upon consolidation of a formed panel.

18. The panel of claim 17 wherein the first and/or second lignocellulosic material is wood, bamboo, sugar cane, grass, straw, or mixtures thereof.
